(19) United States
(12) Patent Application Publication
(10) Pub. No.: US 2014/0066213 A1
(43) Pub. Date: Mar. 6, 2014

(54) DIGITAL INTERACTIVE TOY

(71) Applicant: Junior Cesar de Azevedo Martins, Presidente Prudente (BR)

(72) Inventor: Junior Cesar de Azevedo Martins, Presidente Prudente (BR)

(21) Appl. No.: 13/913,941

(22) Filed: Jun. 10, 2013

(30) Foreign Application Priority Data
Sep. 5, 2012 (BR) BR1020120224046

(51) Int. Cl. A63F 13/02; A63F 9/24

(52) U.S. Cl. CPC A63F 13/02; A63F 9/24
USPC 463/46

(57) ABSTRACT

Digital interactive toy comprises a structure (1) from any shape and theme, providing seats (2) and stands (3) for placing one or more tablets (4) in front of such seats, where users can have fun with different gaming applications, being the interactions effected by touches of the screens of tablets (4).

### CROSS REFERENCE TO RELATED FOREIGN APPLICATIONS

This application claims priority under 35 U.S.C. §119 to Brazilian application No. BR1020120224046 filed Sep. 5, 2012, herein incorporated by reference in its entirety.

This patent of invention refers to a new digital interactive toy, specially a toy with a single structure or modular structure, of any shape and theme, may be an octopus, a sun, a ship, etc., in which is installed multiple tablets touch screen with gaming/educational applications, strategically positioned on said structure so that people/children sit around said structure in a collective way, and have fun/learn positioned ergonomically correct and comfortable, having an infinite number of possible structures and applications.

The pledged toy can be used in game stores/recreational areas in Malls, children's buffets, schools, nurseries and any locations related to recreation/education.

The recreation field has a fierce competition and is one of the fastest growing sectors in the economy in general, however the target audience is eager for news.

In this field, there are several aspects and options, ranging from more radical and mechanical toys, passing by those that simulate a basketball game, soccer, tennis, car racing and related, and, finally, in accordance with the focus of this patent application, the virtual games having several themes, but anyone with platform for being used with tablets.

Likewise, virtual games have become affordable for home practice, where computers with their applications and games go beyond the imagination of any person, such is the reality of actions.

The ease and accessibility of games often discourage people to go out home and have fun, which corroborates the above statement, that for the commercial arm of recreation to keep alive it is necessary the constant renewal of toys.

On the other hand, as it relates to children of small age in places frequented by families, e.g., Malls and buffets, it is nice to have attractive things to distract children, so that parents and/or other adults can talk and have fun too, which becomes totally impractical if children don't have options for recreation.

Yet, related to children of small age or people with no intimacy with computers, it is necessary to insert these into the digital world, both for the reasons of this decrease the barriers in the world we live in, as the reason to leverage the capabilities of interaction and learning that digital media can bring, exercising coordination and expanding children's interest, especially with tablets touch screen, since only these make interaction possible, even for those who still have little coordination.

The current state of the art anticipates some patent documents that deal with the matter under consideration, as MU7300460-0 “Pre-Assembled Kit for Videogame Cabinet”—video games installed in cabinets and driven by chips, whose highlight is the modular construction, thereby facilitating their transport.

The above equipment, despite perform well the function for which it was designed, presents no attraction that distinguishes it from other toys, considering there are similar on the market for years. Furthermore, it is individual and interaction with the images is effected with joysticks, not always easy to handle.

PI0903827-2 “Inflatable Toy Shaped Globe”—manufactured with two plastic globes, one within the other, with spacer of same material and with two external handles to people hold them when inside the globe.

On the other hand, this toy, widely used for playgrounds, does not conflict at all with the patent application claimed since there is not a game.

Aware of the state of the art, its gaps and limiting, inventor, person accustomed to the matter under consideration, after observations and studies, noted that for the use of tablets on the market it had not any self-supporting structure that make feasible its public/collective use, thus it was created the pledged digital interactive toy, to be mounted on a single structure or modular structure, compatible with the local and age of potential users, being coupled several tablets with gaming applications, making thus their use interesting, safe and comfortable, also aesthetically striking

In a way of enabling, the invention may be the theme of a stylized animal with seats and stands for the placement of tablets with touch screens in which the interaction is effected by touches, therefore proposing a friendlier interface, that added to the shape of the structure makes the toy very attractive.

To follow, the invention is explained with respect to the accompanying drawings, in which are represented, by way of illustration and not limitation:

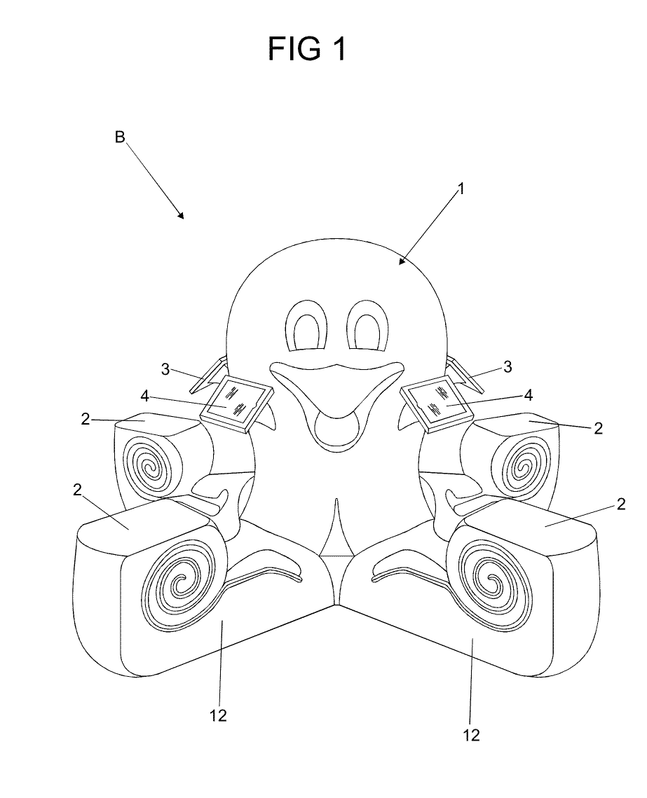

FIG. 1: Perspective view of digital interactive toy mounted on a structure in the shape of a stylized octopus;

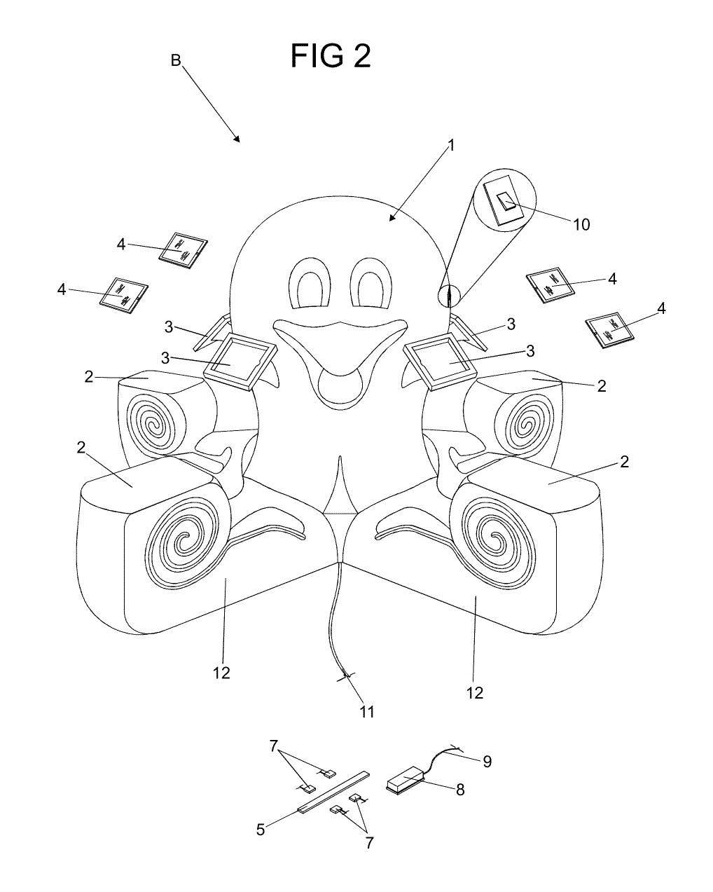

FIG. 2: Exploded perspective view of digital interactive toy mounted on a structure in the shape of a stylized octopus;

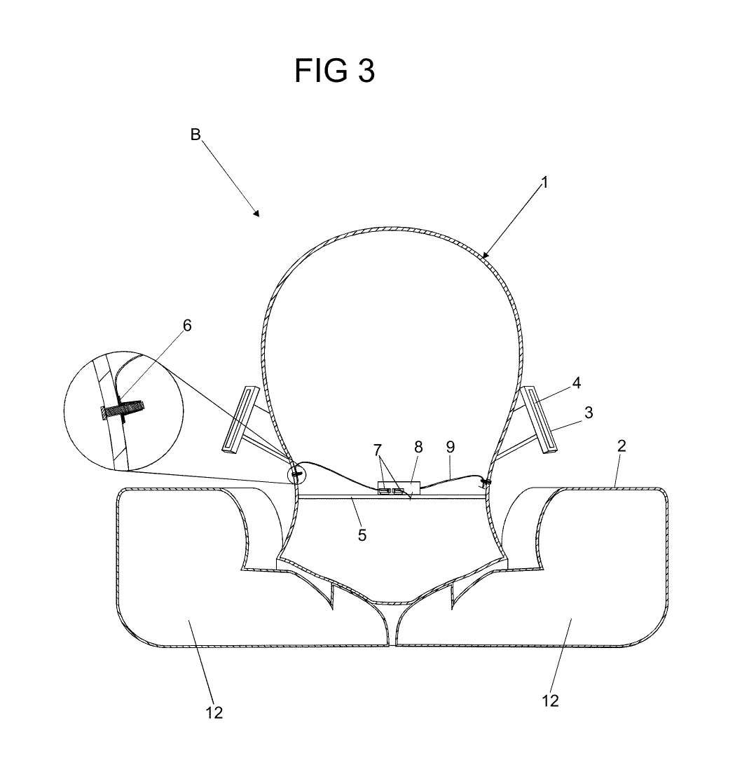

FIG. 3: Sectional view of digital interactive toy mounted on a structure in the shape of a stylized octopus;

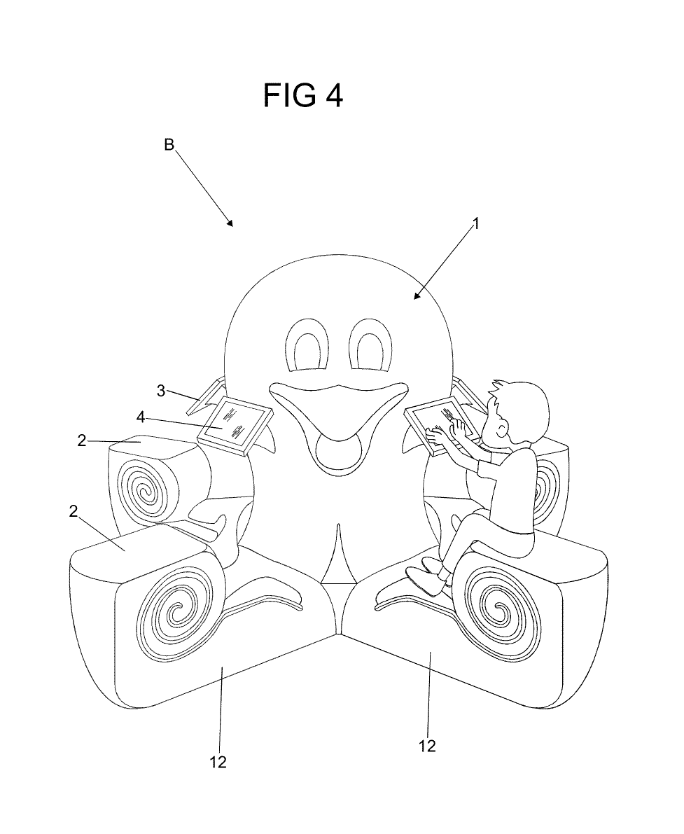

FIG. 4: Perspective view of digital interactive toy mounted on a structure in the shape of a stylized octopus, showing use;

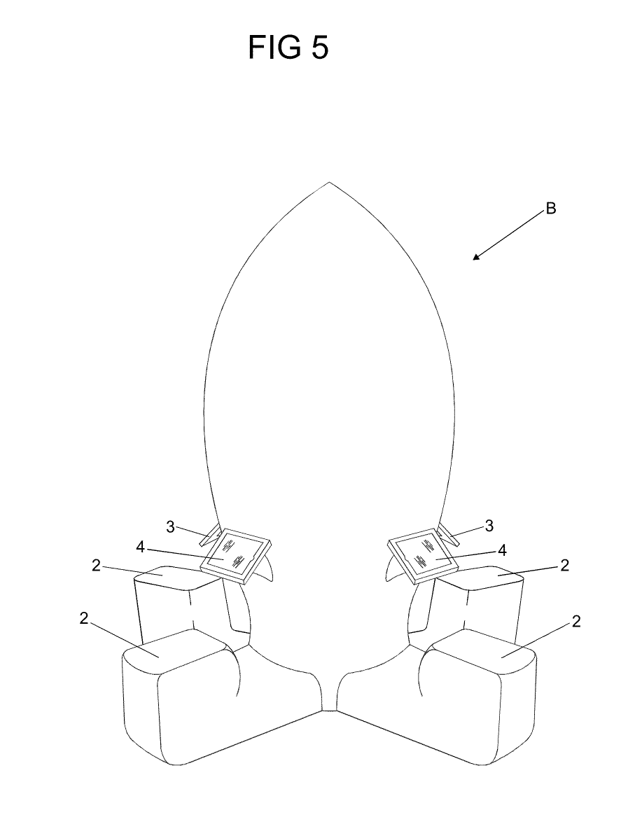

FIG. 5: Perspective view of digital interactive toy mounted on a structure in the shape of a spaceship.

The digital interactive toy of this patent request comprises a structure (1) from any shape and theme, provides seats (2) and stands (3) for placing one or more tablets (4) in front of such seats, where users can have fun with different gaming applications, with interactions being effected by touching the screens of the tablets (4).

More particularly, the created toy (B) comprises a self-supporting structure (1) from any shape, dimension, and theme, providing or not seats (2) and stands (3) in front of said seats for receiving the tablets (4) with their gaming applications, having easy interaction with users due to their touchscreen technology. Internally, the structure (1) has a powerstrip (5), properly grounded (6), for connection of the sources (7) of tablets (4), which have their voltages equalized by stabilizer (8) which derives a connecting cable (9) toward a switch (10) and thence to the external power network (11). According to the FIGS. 1 to 4, in an embodiment, the invention is best represented by a stylized structure (1) in the shape of a octopus, from whose tentacles (12) derive seats (2), while, from the midline and transverse line of head, the stands (3) protrude for the reception of tablets (4), being all electrical part, in other words, powerstrip (5), sources (7) e stabilizer (8), in the basal portion of the inner body of the octopus; the outside part of the octopus comprises the on-off switch (10). In another embodiment, as shown in FIG. 5, the toy (B) is mounted on a spacecraft also stylized.

Thereby, keeping the inventive concept, it is possible to make several structures, collective or individual, as well as a myriad of other gaming applications embedded in the tablets.

1) Digital interactive toy, comprising a self-supporting structure (1), from any shape, dimension and theme, wherein it provides, or not, seats (2) and stands (3) for receiving the tablets (4) with their gaming applications, using touchscreen technology; internally, the structure (1) has a powerstrip (5), properly grounded (6), for connection of the sources (7) of tablets (4), which have their voltages equalized by stabilizer (8) which derives a connecting cable (9) toward a switch (10) and thence to the external power network (11).
